(19) United States
(12) Patent Application Publication
(10) Pub. No.: US 2011/0106552 A1
(43) Pub. Date: May 5, 2011

(54) SYSTEM AND METHOD FOR DELIVERING PERSONALIZED PATIENT DATA

(76) Inventor: Guruprasad K. N., Bangalore (IN)

(21) Appl. No.: 12/610,632

(22) Filed: Nov. 2, 2009

(51) Int. Cl. G06Q 50/00; G06F 17/30

(52) U.S. Cl. 705/2; 707/769; 707/E17.014

(57) ABSTRACT

In one embodiment, a method of personalized patient data delivery as performed by a personalized patient data delivery system is described. The method comprises receiving an emergency patient data request at a mobile network infrastructure via a communication device, determining at least one patient data delivery server comprising requested emergency patient data, transmitting the emergency patient data request to the patient data delivery server, obtaining requested emergency patient data from the patient data delivery server and transmitting the emergency patient data to the communication device.

### CROSS-REFERENCE TO RELATED APPLICATIONS

This application claims priority under 35 U.S.C. §119(a)-(d) or (f) to prior-filed, co-pending Indian patent application serial number 3082/CHE/2008, filed on Dec. 5, 2008, which is hereby incorporated by reference in its entirety.

### BACKGROUND OF THE INVENTION

1. Field of the Invention

The field of the invention relates generally to data delivery on wireless networks including mobile access networks. More particularly, the field of the invention relates to system and methods for providing personalized patient data to mobile users.

2. Description of Related Art

Each healthcare establishment maintains patient data in the form of an electronic health record (EHR). One limitation associated with this system is insufficient infrastructure to interconnect all the healthcare establishments to access any EHR from a single server. The need for this is particularly felt when providing an emergency care. In emergency medicine, the “60 minutes” following a medical emergency can be the difference between life and death. It's called the “golden hour” and is that critical time period within which treatment must begin in order for it to be successful.

In order to begin a treatment, a caregiver has to know critical patient data associated with the patient. The critical patient data is included in the EHR. However, the EHR of the patient seeking the emergency care may not necessarily exist at the same healthcare establishment where the emergency care is provided. As a result of this, the caregiver may not be able to administer emergency care within the golden hour, as he is unable to access the critical patient data.

Hence there exists a need for accelerated methods of providing patient data in case of an emergency.

### BRIEF SUMMARY OF THE INVENTION

The above-mentioned shortcomings, disadvantages and problems are addressed herein which will be understood by reading and understanding the following specification.

In one embodiment, a method of personalized patient data delivery as performed by a personalized patient data delivery system is described. The method comprises receiving an emergency patient data request at a mobile network infrastructure via a communication device, determining at least one patient data delivery server comprising requested emergency patient data, transmitting the emergency patient data request to the patient data delivery server, obtaining requested emergency patient data from the patient data delivery server and transmitting the emergency patient data to the communication device via the mobile network infrastructure.

In another embodiment, a method of personalized patient data delivery is described. The method comprises acquiring an emergency patient data request input from a user at a communication device, transmitting an emergency patient data request to a mobile network infrastructure by the communication device, receiving the emergency patient data request at the mobile network infrastructure, determining at least one patient data delivery server comprising requested emergency patient data, the patient data delivery server deployed within the network domain of a mobile service provider, transmitting the emergency patient data request to the patient data delivery server and suitably processing transmitted emergency patient data request to obtain requested emergency patient data.

In yet another embodiment, a method of delivering personalized patient data to communication devices is provided. The method comprises acquiring an emergency patient data request input from a user at a communication device, transmitting an emergency patient data request to mobile network infrastructure coupled to the communication device, determining at least one patient data delivery server comprising requested emergency patient data, transmitting the emergency patient data request to the patient data delivery server, processing transmitted emergency patient data request by the patient data delivery server to format a suitable database query, obtaining emergency patient data from a patient database based on the database query and transmitting the emergency patient data to the communication device for suitable processing to render the emergency patient data to the user.

In yet another embodiment, a personalized patient data delivery system comprising a communication device to acquire emergency patient data request input from a user, a mobile network infrastructure to transmit an emergency patient data request based on the emergency patient data request input received at the communication device, a patient data delivery server deployed within a mobile operator network and/or remotely deployed network to process the emergency patient data request and at least one patient database coupled to the patient data delivery server, the at least one patient database storing the emergency patient data, is provided.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE SEVERAL VIEWS OF THE DRAWINGS

FIG. 1 is a schematic representation of a personalized patient data delivery system in accordance with an embodiment of the invention;

FIG. 2 is block diagram representation of a patient data delivery server in accordance with an embodiment of the invention;

FIG. 3 is a flow chart of a method of personalized patient data delivery to a communication device, as performed by the personalized patient data delivery system in accordance with an embodiment of the invention; and

FIG. 4 is a timing diagram that represents the operation of the personalized patient data delivery system, in accordance with an embodiment of the invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The invention provides system and method for providing emergency patient data on a communication device using unique combination of keys, standard across all mobile service providers or mobile operators, such as Sprint and Nextel in USA and Airtel and Vodafone in India. This can be provided as a free service or a value added service provided by the mobile service providers.

The mobile service providers can tie up with one or more patient data providers for fetching emergency medical information. The patient data providers include healthcare establishments or third party healthcare providers hosting one more patient data delivery servers. The third party healthcare providers may include Google Health and HealthVault. Each patient data delivery server comprises EHR of several patients associated with the respective healthcare establishment. One or more such patient data delivery servers can be linked to the value added service provided by the mobile service provider.

A request for emergency patient data can be treated analogous to Morse code distress signal (SoS), which is the worldwide standard for emergency dialing. Upon receiving the request for emergency patient data, the mobile service provider can route the request to a patient data delivery server, which fetches the emergency patient data and presents the emergency patient data to the mobile service provider. The emergency patient data can further be transmitted to the communication device for processing and display.

The invention may be described herein in terms of schematic, functional and/or logical block components and various processing steps. It should be appreciated that such block components may be realized by any number of hardware, software, and/or firmware components configured to perform the specified functions. The invention may be realized employing various integrated circuit components, e.g., memory elements, processing elements, communication elements, logic elements, look-up tables, or the like, which may carry out a variety of functions under the control of one or more microprocessors or other control devices.

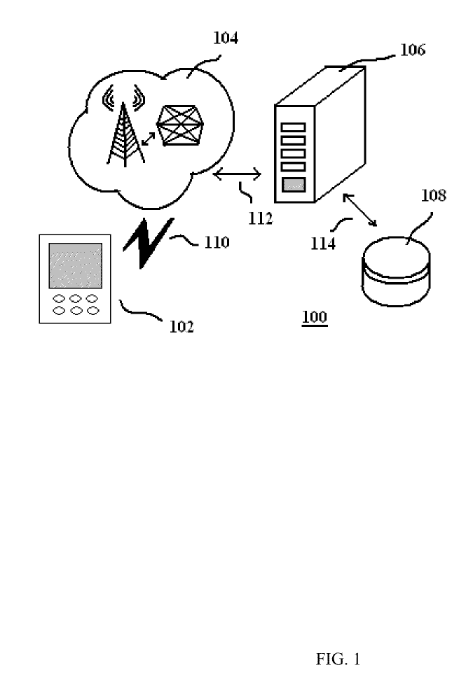

FIG. 1 is a schematic representation of a personalized patient data delivery system 100. The personalized patient data delivery system 100 and related techniques described in more detail below can be implemented in a mobile access network as shown in FIG. 1. The personalized patient data delivery system 100 generally includes a wireless communication device 102, a mobile network infrastructure 104 setup by a mobile service provider/operator, a patient data delivery server 106 deployed within the mobile operator network or remotely deployed network, and a patient database 108.

Communication devices 102 include mobile or cellular phones, smart phones, personal digital assistants (“PDAs”) supporting mobile connectivity, palmtop computers supporting mobile connectivity, laptop mobile computers supporting mobile connectivity, and the like.

The communication devices 102 access emergency patient data over the mobile network infrastructure 104 generally deployed and managed by the mobile service providers like Cingular and Verizon Wireless in the USA, Airtel and Vodafone in India. In one embodiment, a mobile service provider can include mobile operators, Internet service providers and value added service providers.

The emergency patient data comprises medical information concerning a patient such as identity, age, height, weight, sex, family and genetic medical data, medical history, physical handicaps, known medical conditions, known medical allergies, and current ailment conditions such as symptoms and duration, blood group data, prescriptions, drug interaction information, drug treatment information, radiology information, laboratory information and clinical information and the like.

Further, the emergency medical data may comprise contact details of the patient including the residence address, contact number (other than mobile phone) along with contact details of a primary caregiver such as a family physician. This detail is useful for the caregivers providing emergency care to contact one or more persons associated with the patient.

In practice, the user may send a standard SMS text message as predefined by the mobile service provider to request an emergency patient data. The process begins with the communication device 102 receiving an emergency patient data request input from a user. The communication device 102 sends the emergency patient data request to the mobile network infrastructure 104 in accordance to the wireless communication protocols utilized by the mobile network infrastructure 104. The emergency patient data request may be realized as one or more emergency patient data packets, for accessing desired emergency patient data from one or more patient databases 108.

Thereafter, the emergency patient data request is handled by the mobile network infrastructure 104 suitably and transmits the emergency patient data request to the network domain of the mobile service provider hosting the patient data delivery server 106 and the patient databases 108. The operation of mobile network infrastructure 104 is not described herein as it is know to those skilled in the art.

The patient data delivery server 106 may simply forward the emergency patient data request to patient database 108 as a suitably formatted database query. The Patient database 108 suitably responds with the requested emergency patient data. The requested emergency patient data is sent to the mobile network infrastructure 104 in a suitable format as needed. The mobile network infrastructure 104 then sends the requested emergency patient data over the wireless link to the communication device 102 of the user. The requested emergency patient data is suitably processed by the communication device 102 to render the emergency patient data to the user.

The wireless communication device 102 supports wireless communication with mobile network infrastructure 104 via a wireless link 110. Such wireless communication, characteristics of wireless link 110, and the manner in which wireless link 110 is created and maintained may be governed by one or more applicable wireless communication protocols and/or one or more applicable signaling and network protocols. In an exemplary embodiment, wireless communication device 102 is configured to support Wireless GSM/GPRS/3G/CDMA/W-CDMA connectivity in compliance with established European Telecommunications Standards Institute (ETSI) standards, International Telecommunication Union (ITU) standards and Third Generation Partnership Project (3GPP) standards and the like.

In one embodiment, communication between the patient data delivery server 106 and mobile network infrastructure 104 follows either standard [like Web Services, or over HTTP] or proprietary protocols and the data exchanged may be defined using either known standards like CDA (Clinical Document Architecture) or XML or proprietary data formats.

Further, wireless communication device 102 may be configured to support alternate or additional wireless data communication protocols, including future variations of 3G such as 3.9G or 4G. The wireless communication device 102 may also utilize other technologies like Bluetooth; IEEE 802.11a/b/g (WLANs); IEEE 802.16 (WiMAX); IEEE 802.20 etc.

The patient data delivery server 106 couples with the mobile network infrastructure 104 via the communication link 112 and with the patient database 108 using the communication link 114. The patient data delivery server 106 can communicate with the patient database 108 to retrieve emergency patient data as requested by the user, and/or transmit requested emergency patient data in an appropriate format for presentation at the wireless communication device 102 in the GSM/GRPS/3G world. The manner in which a data communication channel 114 is established and maintained over physical link may be governed by one or more applicable data communication protocols, one or more database management protocols, and/or one or more applicable network protocols.

In practice, the patient database 108 may leverage well-known data storage, database management, and other database-related technologies. The manner in which emergency patient data is accessed and retrieved by the patient data delivery server 106 from patient database 108 complies with conventional protocols and standards. Practical implementations of the patient database 108 may be implemented on single computer or server architecture or on multiple computers or servers that may be interconnected through a network, such as the Internet, local area network or wide area network. Also software, and emergency patient data associated with the system 108 may reside on a single computer architecture system or server, or may be distributed across the multiple computers systems or servers.

The patient database 108 can be suitably configured to handle all types of data including, but not limited to Hyper Text Transfer Protocol (HTTP) Web pages, XML pages, RSS feed formats, WAP pages, MPEG files, MOV files, JPEG files and GIF files. The patient database 108 may also reside on known data servers like the Apache Web servers, Microsoft data management servers, Microsoft XP servers or Windows 2003 servers, Real Networks Helix servers, Tandberg data servers, and Apple Quicktime servers etc.

The patient data delivery server 106 when coupling with the mobile network infrastructure 104 and when coupling with the patient databases 108 or patient data servers may include other traditional connectors, LAN data cables, LAN switches like Cisco 3500 series, Internet routers like Cisco 7200 series, Load Balancers and data Services Switches like Cisco CSS 11500 family series, Firewalls and VPN security devices etc. The patient data delivery server 106 may also be coupled with other application servers including, but not limited to SMS application servers, MMS application servers and the like.

The patient data delivery server 106 may be implemented on single computer or server architecture or on multiple computers or servers that may be interconnected through a network, such as the Internet or local area network. Also software and emergency patient data storage associated with the system 106 may reside on a single computer architecture system or server, or may be distributed across the multiple computers systems or servers.

The system 106 may integrate with existing types of computer software, such as computer operating systems, network operating systems, mobile telecommunication protocols, and internet transport protocols, special purpose devices such as “Content Delivery Platforms” or “Service Delivery Platforms”, interactive voice response systems (IVR), 3G IP Multimedia Subsystem (IMS), database software, application middleware, application software and/or application servers like SMS application server, MMS application server etc., databases, database servers and streaming data servers. In addition, those skilled in the art will appreciate that the invention may be practiced in conjunction with any number of telecommunication and data transmission protocols and that the system described herein is merely one exemplary application for the invention.

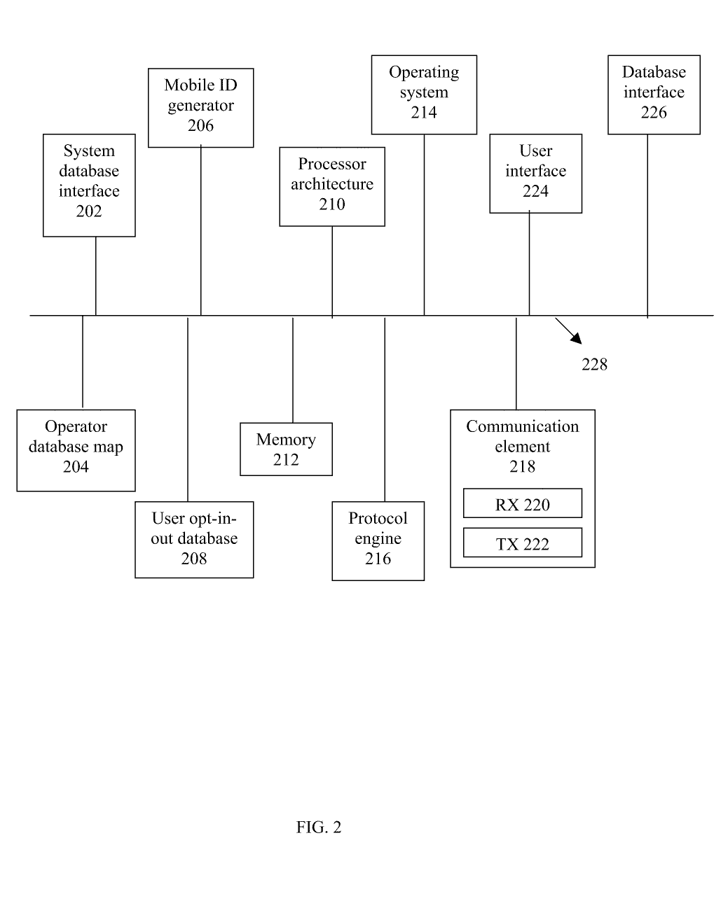

FIG. 2 is a schematic representation of the patient data delivery server 106 in accordance to one exemplary embodiment. The patient data delivery server 106 is suitable to be used in the personalized patient data delivery system 100. The patient data delivery server 106 generally includes a system database interface 202, operator database map 204, a mobile ID generator 206, a user opt-in-out database 208, processor architecture 210, memory 212, an operating system 214, protocols engine 216, communication element 218 with receive element 220 RX and transmit element 222 TX, a user interface 224 and database interface 226. The patient data delivery server 106 may include a suitable interconnect architecture 228 that couples the various elements together. Interconnect architecture 228 allows the various elements of the patient data delivery server 106 to communicate with each other and transfer data as needed.

The system database interface 202 may represent hardware, software, and/or processing logic that enables sub-systems of the patient data delivery server 106 to communicate with system databases like operator database map 204 and user opt-in-out database 208 using the native language, database management protocols, and nomenclature of the database. For example, the system database interface 202 is suitably configured to create a database query for an emergency patient data requested by a user. The system database interface 202 formats the database query for compliance with the patient database 108, and makes the database query available for transmission to the patient database 108. Furthermore, the system database interface 202 obtains the requested emergency patient data (or a portion thereof) from the patient database 108 so that patient data delivery server 106 can process the requested emergency patient data in an appropriate manner.

Operator database map 204 is a database comprising information about mobile subscribers and associated information. Accordingly, the operator database map 204 comprises two internal databases. A first internal database comprises user data collected by the mobile service providers and a second internal database comprises identification details of one or more patient databases 108 to be used by the mobile operators to deliver emergency patient data to its subscribed users. The consent of the user for using this information can also be obtained from the mobile service provider. This data is restricted and governed by legislations and guidelines as provided by the mobile service provider.

In one embodiment, the operator database map 204 links the patient identity stored in the EHR with the identity information of a user stored in the first internal database. The user using the communication device 102 can subscribe to this service. Following the subscription, basic information that helps in associating the user with the medical records stored at a healthcare establishment, such as identification details of the user, contact details of the user, identification details of one or more healthcare establishments the user is associated with along with registration number or any such number identifying the medical records of the user stored in the respective healthcare establishment can be obtained by the mobile service provider. Consequently, the patient identity in EHR can be linked to the identity information stored in the first internal database.

In one embodiment, the operator database map 204 may also include an alias to an original contact number to hide and/or protect the privacy of the user. For example, a user in India with a mobile number +919980803210 may be represented in this operator database map 204 with an alias so that the original mobile number is not exposed outside. This can be any uniquely identifiable number called a mobile ID which maps on to the original mobile number of the user, as provided by the mobile operator. Mobile ID can be any uniquely identifiable number generated and designated by the mobile ID generator 206 of the patient data delivery server 106 for all internal references, storage and processing of associated attributes. The unique number generation is known to those skilled in the art and is hence not described herein.

In one embodiment, the mobile service providers provide mobile services to users of the communication device 102 (referred to herein as users) based on a subscription model, where the users pay for the emergency patient data and other supplementary services. The user opt-in-out database 208 comprises user preference of opting-in for receiving emergency patient data upon placing an emergency patient data request input or opting-out of receiving emergency patient data. The patient data delivery server 106 does not deliver any personalized patient data for users who have opted-out for receiving emergency patient data by this patient data delivery server 106.

The system databases of the patient data delivery server 106 namely, operator database map 204, user opt-in-out database 208, may be automatically updated based on the users' interaction with the patient data delivery server 106 and various elements of this sub-system. The system databases of the patient data delivery server 106 may use any native language, database management protocols, and nomenclature of the database and may be any commercially available databases like Microsoft SQL, Oracle database like Oracle 10 g etc.

Processor architecture 210 may be implemented or realized with a general purpose processor, an application specific integrated circuit, discrete hardware components, or any combination thereof, designed to perform the functions described herein. A processor may also be implemented as a combination of computing devices, e.g., a combination of microprocessors, central processing units (CPUs), a plurality of microprocessors, configuration of microprocessors in single core or multi-core architectures, or any other such configuration. The processor architecture 210 can communicate with the various components and functional elements of the patient data delivery server 106 and carry out processing tasks and techniques described herein.

Memory 212 may be implemented or realized with RAM/ROM memory, flash memory, EPROM/EEPROM memory, cache memory, hard disk, a removable disk, a CD-ROM, or any other form of storage medium and perform storage functions. In this regard, the memory 212 can be coupled to any component of the patient data delivery server 106 such that any component can read information from, and write information to the memory 212. The memory 212 includes sufficient data storage capacity to support the operation of the patient data delivery server 106 described herein.

Operating system 214 (OS) is associated with computing platform as required by the patient data delivery server 106. The operating system 214 may be any suitable operating system 214 such as Unix OS, Microsoft Windows Server OS, Linux on Advanced Telecom Computing Architecture (AdvancedTCA), Montavista Carrier Grade Linux Edition (CGE), Sun Microsystems Solaris OS or the like.

The protocols engine 216 is associated with computing platform as required by the patient data delivery server 106. The protocols engine 216 may include any protocol stacks for network access, signaling protocols, telecommunication protocols, data communication protocols and/or other transport protocols required by the patient data delivery server 106 to interface, communicate and/or transfer emergency patient data over the mobile network infrastructure 104 and/or interface, communicate, transfer emergency patient data from/to the patient database 108 including, but not limited to GSM/GPRS/3G/CDMA/WCDMA protocol stacks, SMSC/MMSC interfacing protocol stacks, Internet protocol stacks like TCP/IP, UDP, RTCP, SNMP and application level protocols like SMS application protocols etc. The protocols engine 216 architecture may also include middleware and application protocols like JBOSS Enterprise Middleware suite, Common Object Request Broker Architecture (CORBA), JAVA middleware suites (like J2EE) etc.

The functionality of processor architecture 210, memory 212, operating system 214, protocols engine 216, communication element 218, interconnect architecture 228 and the manner in which it governs the architectural, functional and operational aspects of the patient data delivery server 106 are known to those skilled in the art and will not be described herein.

The communication element 218 generally refers to features and components, including hardware, drivers, software etc., that enable the patient data delivery server 106 to communicate with mobile network infrastructure 104, other network components and devices like load balancers, firewalls, SMS application servers, database servers using receive element RX 220 and transmit element TX 222 using standard communication protocols and/or utilizing the protocols engine 216 of the patient data delivery server 106.

The user interface 224 refers to any graphical, textual, auditory, command line interface provided to the administrator/user of the patient data delivery server 106 to control the operation and functionality of the patient data delivery server 106. It also refers to any graphical, textual, auditory, command line information the patient data delivery server 106 presents to the administrator/user.

The database interface 226 may represent hardware, software, and/or processing logic that enables the patient data delivery server 106 to communicate with patient databases 108 and/or data hosted on data servers like Tandberg data servers, and Apple Quicktime servers etc., using the native language, database management protocols, and nomenclature of the database. For example, the database interface 226 is suitably configured to create a database query for an emergency patient data, requested by the user, using the patient data delivery server 106, and deliver the emergency patient data requested by the user in a format that is suitable for transmission by the patient data delivery server 106. Moreover, the database interface 226 obtains the requested emergency patient data (or a portion thereof) from the patient database 108 and/or patient data server, so that the patient data delivery server 106 can process the requested emergency patient data in an appropriate manner.

Conventional techniques related to computer device platforms, wireless telecommunication and data transmission, signaling network control, database management, and other functional aspects of the patient data delivery server 106 (and the individual operating components) may not be described in detail herein as it is known to those skilled in the art. Furthermore, the connecting lines shown in FIG. 1 and FIG. 2 comprised herein are intended to represent functional relationships and/or physical couplings between various elements. In practical embodiment, additional functional relationships or physical connections may be present.

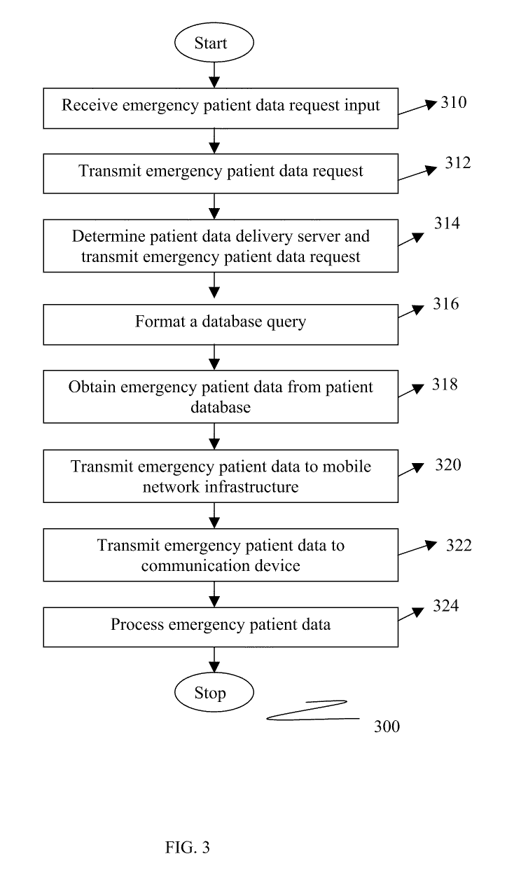

FIG. 3 is a flow chart of a method 300 of personalized patient data delivery to a communication device 102, as performed by the personalized patient data delivery system 100. For illustrative purposes, the following description of the method 300 may refer to elements mentioned above in connection with FIG. 1 and FIG. 2. In practical embodiments, portions of this method 300 may be performed by different elements of the described system 100, e.g., the communication device 102, the mobile network infrastructure 104 or the patient data delivery server 106. It should be appreciated that the method 300 may include any number of additional or alternative tasks, and need not be performed in the illustrated order, and the method 300 may be incorporated into a more comprehensive procedure or process having additional functionality not described in detail herein.

The method 300 of delivering personalized patient data begins with a communication device 102 acquiring an emergency patient data request input from the user. This is depicted at step 310 in the flowchart. Acquiring the emergency patient data request input comprises dialing a predetermined emergency service key by a user requiring emergency service. The predetermined emergency key service may be a unique sequence of keys which when activated/pressed/dialed on the communication device 102, initiate the method of personalized patient data delivery.

Alternatively, the predetermined emergency service key may include sending a standard SMS text message requesting emergency patient data to a predetermined number. The standard SMS text message may include predetermined sequence of numerical and/or alphabetical keys. For example: the standard SMS text message may include “EPD 911” that when sent to the predetermined number “999” may place emergency request for retrieving emergency patient data.

The communication device 102 transmits an emergency patient data request, based on received emergency patient data request input, via a wireless link. The flow chart 300 depicts the wireless transmission of the emergency patient data request at the step 312. Thereafter, the emergency patient data request is handled by the mobile network infrastructure 104 suitably. The mobile network infrastructure 104 determines at least one patient data delivery server 106 storing requested emergency patient data. Flow chart 300 depicts this at the step 314. Subsequent to determining the patient data delivery server 106, the mobile network infrastructure 104 transmits the emergency patient data request to the network domain of the mobile service provider hosting the patient data delivery server 106 and the required patient databases 108.

The patient data delivery server 106 may simply forward the emergency patient data request to the patient database 108 as a suitably formatted database query denoted by the step 316 in the flow chart. The patient database 108 suitably responds with the requested emergency patient data shown at the step 318 in the flow chart 300. The requested emergency patient data is sent to the mobile network infrastructure 104 in a suitable format and this is depicted at the step 320 in the flow chart 300. The mobile network infrastructure 104 then sends the emergency patient data over the wireless link to the communication device 102 as depicted by the step 322 in the flow chart 300. The emergency patient data is suitably processed by the communication device 102 to render the emergency patient data to the user, as depicted by the step 324.

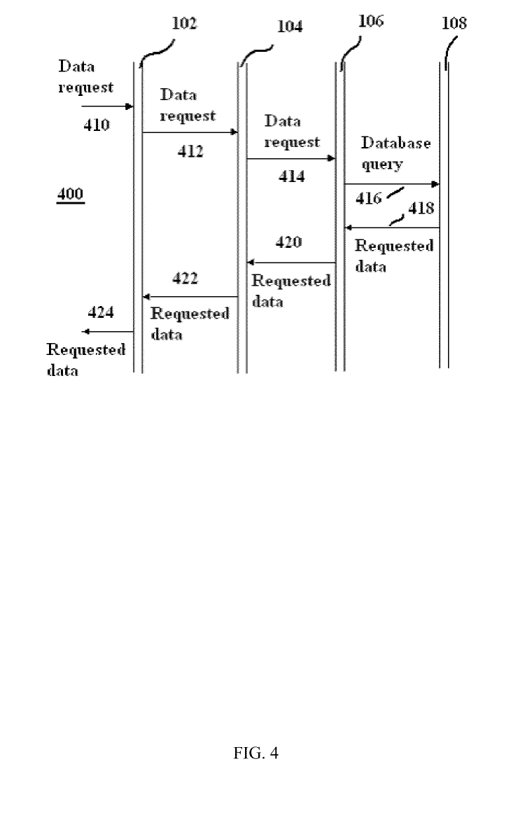

FIG. 4 represents a timing diagram depicting the occurrence of events when the user requests the emergency patient data, till the patient data delivery system 100 delivers the desired emergency patient data to the user.

The operation of the personalized patient data delivery system 100 begins with the communication device 102 acquiring an emergency patient data request input from the user. The timing diagram 400 identifies the emergency patient data request input with an arrow 410. The communication device 102 transmits an emergency patient data request, based on the emergency patient data request input received, via a wireless link to the mobile network infrastructure 104. The timing diagram 400 depicts the wireless transmission of the emergency patient data request with an arrow 412.

Thereafter, the emergency patient data request is handled by the mobile network infrastructure 104. The mobile network infrastructure 104 identifies at least one patient data delivery server 106 storing requested emergency patient data and transmits the emergency patient data request to the network domain of the mobile service provider hosting the patient data delivery server 106. Timing diagram 400 depicts this transmission of the emergency patient data request to the patient data delivery server 106 with an arrow 414. The patient data delivery server 106 receives the emergency patient data request and suitably processes the emergency patient data request.

The patient data delivery system 100 may format a suitable database query for compliance with the patient database 108 and query the patient database 108 for the required emergency patient data. This is denoted by the arrow 416 in the timing diagram. The patient database 108 suitably responds with the requested emergency patient data shown by the arrow 418 in the timing diagram 400.

The emergency patient data is sent to the mobile network infrastructure 104 in a suitable format and this is depicted with an arrow 420 in the timing diagram 400. The mobile network infrastructure 104 then sends the emergency patient data, over the wireless link, to the communication device 102 of the user, depicted by the arrow 422 in the timing diagram 400. The emergency patient data represented by the arrow 422 is suitably processed by the communication device 102 to render the emergency patient data, as depicted by the arrow 424, to the user.

The personalized patient data delivery system 100 described in various embodiments enables a caregiver to obtain emergency medical information concerning a patient using the communication device 102 used by the patient. This can be achieved without interacting with or disturbing the patient.

The patient can be assured of a quick and efficient medical care, as the emergency medical information that includes vital and accurate clinical information is easily available to the care provider. This is particularly useful during emergencies such as treating accident victims or people who are on the move and hence not within the range of their healthcare provider.

Patient privacy and security concerns are addressed as only emergency medical information is obtained with prior consent from the patient.

The system and method for delivering personalized patient data make use of an existing infrastructure. Further, there is no need for any special application to run on the communication device 102. Usage of a standard service key or a predetermined key combination initiates the process of obtaining emergency patient data and therefore eliminates the need for the care caregiver to know the usage of each model of the communication device 102.

In one embodiment, the invention makes use of a mobile phone, carried generally by a person irrespective of the economic strata the person belongs to. This eliminates the need for carrying additional data storage medium like a removable disk, compact disk (CD) or a pen drive to store emergency medical information of the patient.

The feature of providing emergency medical information on the mobile phone is a good value add to the subscribers of a mobile service provider.

In various embodiments, system and method for obtaining emergency patient data are described. However, the embodiments are not limited and may be implemented in connection with different applications. The application of the invention can be extended to other areas. The invention provides a broad concept of providing personalized data on request, which can be adapted to obtain data other than medical information in a variety of applications. Accordingly, the invention is not limited to a healthcare environment. The design can be carried further and implemented in various forms and specifications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of personalized patient data delivery as performed by a personalized patient data delivery system, the method comprising:
receiving an emergency patient data request at a mobile network infrastructure via a communication device;
determining at least one patient data delivery server comprising requested emergency patient data;
transmitting the emergency patient data request to the patient data delivery server;
obtaining requested emergency patient data from the patient data delivery server; and
transmitting the emergency patient data to the communication device via the mobile network infrastructure.

2. The method of claim 1, wherein the emergency patient data request is in accordance to the wireless communication protocols utilized by the mobile network infrastructure.

3. The method of claim 1, wherein the emergency patient data request is realized as one or more data packets, for accessing desired emergency patient data from the patient data delivery server.

4. The method of claim 1, further comprising displaying the emergency patient data at the communication device.

5. The method of claim 4, further comprising suitably processing the emergency patient data at the communication device to render the emergency patient data to a user.

6. The method of claim 1, further comprising:
formatting a database query by the patient data delivery server;
sending the database query to the patient database coupled to the patient data delivery server; and
receiving requested emergency patient data from the patient database.

7. A method of personalized patient data delivery, the method comprising:
acquiring an emergency patient data request input from a user at a communication device;
transmitting an emergency patient data request to a mobile network infrastructure by the communication device;
receiving the emergency patient data request at the mobile network infrastructure;
determining at least one patient data delivery server comprising requested emergency patient data, the patient data delivery server deployed within the network domain of a mobile service provider;
transmitting the emergency patient data request to the patient data delivery server; and
suitably processing transmitted emergency patient data request to obtain requested emergency patient data.

8. The method of claim 7, further comprising:
transmitting emergency patient data to the mobile network infrastructure in a predefined format;
receiving emergency patient data at the mobile network infrastructure;
sending received emergency patient data to the communication device of the user; and
processing the emergency patient data by the communication device to render the emergency patient data to the user.

9. The method of claim 7, wherein processing the emergency patient data request comprises:
formatting a suitable database query for compliance with at least one patient database;
querying the patient database for required emergency patient data; and
receiving requested emergency patient data from the patient database.

10. The method of claim 7, wherein acquiring the emergency patient data request input comprises dialing a predetermined emergency service key by the user requiring emergency service.

11. A method of delivering personalized patient data to communication devices, the method comprising:
acquiring an emergency patient data request input from a user at a communication device;
transmitting an emergency patient data request to mobile network infrastructure coupled to the communication device;
determining at least one patient data delivery server comprising requested emergency patient data;
transmitting the emergency patient data request to the patient data delivery server;
processing transmitted emergency patient data request by the patient data delivery server to format a suitable database query;
obtaining emergency patient data from a patient database based on the database query; and
transmitting the emergency patient data to the communication device for suitable processing to render the emergency patient data to the user.

12. The method of claim 11, further comprising transmitting the emergency patient data to the mobile network infrastructure.

13. The method of claim 12, wherein the method transmits the emergency patient data to the communication device in accordance with a wireless communication protocol utilized by the mobile network infrastructure.

14. The method of claim 11, wherein acquiring the emergency patient data request input comprises dialing a predetermined emergency service key by a user requiring emergency service.

15. A personalized patient data delivery system comprising:
a communication device to acquire emergency patient data request input from a user;
a mobile network infrastructure to transmit an emergency patient data request based on the emergency patient data request input received at the communication device;
a patient data delivery server deployed within a mobile operator network and/or remotely deployed network to process the emergency patient data request; and
at least one patient database coupled to the patient data delivery server, the at least one patient database storing the emergency patient data.

16. The system of claim 15, wherein the communication device is a wireless mobile device configured to support wireless GSM/GPRS/3G/CDMA/W-CDMA connectivity in compliance with established European Telecommunications Standards Institute (ETSI), International Telecommunication Union (ITU) standards and Third Generation Partnership Project (3GPP) standards.

17. The system of claim 16, wherein the communication device is further configured to supports alternate or additional wireless data communication protocols comprising future variations of 3G including 3.9G/4G, and other wireless communication standards including BlueTooth, WLANs (802.11a/b/g) and WiMAX (802.16).

18. The system of claim 15, wherein the patient data delivery server communicates with the patient database to retrieve emergency patient data as requested by the user, and/or transmits the emergency patient data in an appropriate format for presentation at the communication device.

19. The system of claim 15, wherein the patient data delivery server comprises a system database interface, operator database map, a mobile ID generator, a user opt-in-out database, processor architecture, memory, an operating system, protocols engine, communication element with receive element RX and transmit element TX, a user interface and database interface.

20. The system of claim 19, wherein the system database interface enables sub-systems of the patient data delivery server to communicate with system database selected from a group consisting of operator database map, user opt-in-out database, database management protocols, and nomenclature of the database.

21. The system of claim 19, wherein the operator database map comprises two internal databases, wherein a first internal database comprises user data collected from a mobile operator and a second internal database comprises identification details of one or more patient databases to be used by the mobile operator to deliver patient data to subscribed users

22. The system of claim 19, wherein the processor architecture is realized with a general purpose processor, an application specific integrated circuit, discrete hardware components or any combination thereof.

23. The system of claim 19, wherein the emergency patient data request is transmitted from the communication device to the mobile network infrastructure via a communication link using wireless communications protocols.

24. The system of claim 15, wherein the patient data delivery server is one of an Electronic Medical Record (EMR), Public Health Record (PHR), Enterprise Clinical Information System and Hospital Information System (HIS).

25. The system of claim 15, wherein the communications device is one of a cell phone, Personal Digital Assistant (PDA) and laptop computer with wireless access.
